(19) United States
(12) Patent Application Publication
(10) Pub. No.: US 2005/0253377 A1
(43) Pub. Date: Nov. 17, 2005

(54) Combination blank and preprinted prescription scripts with complimentary sample designation

(76) Inventor: Joshua Lapsker, Christ Church (BB)

Correspondence Address: KLAUBER & JACKSON, 411 HACKENSACK AVENUE, HACKENSACK, NJ, 07601, US

(21) Appl. No.: 11/139,429

(22) Filed: May 27, 2005

Related U.S. Application Data
(63) Continuation-in-part of application No. 10/881,704, filed on Jun. 30, 2004.
(63) Continuation-in-part of application No. 10/865,500, filed on Jun. 10, 2004.
(63) Continuation-in-part of application No. 10/842,835, filed on May 11, 2004.

(51) Int. Cl. G09F 1/00

(52) U.S. Cl. 283/103

(57) ABSTRACT

A combination blank and preprinted prescription script assembly with complimentary sample means that facilitates distribution of prescription pharmaceuticals to patients.

### RELATED APPLICATION

This application is a Continuation-in-Part of co-pending application Ser. No. 10/881,704, filed Jun. 30, 2004, which is a Continuation-in-Part of co-pending application Ser. No. 10/865,500, filed Jun. 10, 2004, which is a Continuation-in-Part of application Ser. No. 10/842,835, filed May 11, 2004, the entirety of each of these applications is hereby incorporated by reference.

### BACKGROUND OF THE INVENTION

1. Field of the Invention

The present invention relates to a combination blank and preprinted prescription scripts with complimentary sample designation for the dispensing of prescription pharmaceuticals.

2. Description of the Related Art

Certain pharmaceuticals are only available for purchase with a written prescription from a physician. Typically, the physician writes out a prescription (sometimes known as an “Rx”), for an appropriate medication for a patient, which the patient then takes to a pharmacist who dispenses the medication in accordance with the handwritten prescription. During the visit to the doctor's office, the patient also usually receives a sample of the prescription to be filled.

The current approach to writing prescription scripts can be somewhat problematic. From a safety standpoint, physicians may write down the wrong medication name or dosage, or more commonly, write a medication name so illegibly, that the filling pharmacist dispenses the wrong medication and/or dosage. To this end, a solution to these shortcomings is needed, especially one which would be convenient for physicians to use in their daily practice.

The current approach of providing complimentary pharmaceuticals can also be fraught with problems. From a drug control standpoint, samples may be lost or stolen at a doctor's office. In terms of safety, samples may become old or expired. Other times, it may be inconvenient for physicians to use samples in their daily practice because of storage space and temperature requirements, or because it is a hassle to retrieve the samples in the course of a hectic day. Moreover, even though doctors enjoy offering free samples on the spot to their patients, safety may actually be compromised by the present practice: typically it is the patient's pharmacist, not the doctor, who knows the entire grouping of medications that a patient may have been taking and may best be able to prevent adverse drug interactions from occurring. In the above regards, there is a need for providing samples in a convenient, safe, efficient manner.

### SUMMARY OF THE INVENTION

It is therefore an object of the present invention to provide a system for enabling the convenient dispensing of sample drugs, without the need to retrieve stored samples or separate coupons.

It is therefore an additional object of the present invention to provide an assembly comprising as components a plurality of preprinted prescription sheets, for convenient, reduced-error writing of prescriptions, and a plurality of blank prescription scripts for the convenience of the prescribing doctors who wish to prescribe medications beyond a given stock of preprinted medications for their patients without the need to carry around multiple pads.

Additional objects, advantages and other novel features of the invention will be set forth in part in the description that follows and in part will become apparent to those skilled in the art upon examination of the following or may be learned with the practice of the invention.

### BRIEF DESCRIPTION OF THE DRAWINGS

The accompanying drawings which are incorporated in, and constitute a part of the specification, illustrate a preferred embodiment of the invention and, together with the general description given above, and the detailed description of the preferred embodiment given below, serve to explain the principles of the invention.

FIG. 1 is an offset view of inventive combination blank and preprinted prescription scripts assembly with the complimentary prescription sample designation included therein in an opened position;

FIG. 2 is an offset view of the inventive combination blank and preprinted prescription scripts assembly with the complimentary prescription sample designation included therein in an opened position, showing an exemplary rendering of preprinted scripts having the complimentary prescription sample designation thereon; and

FIG. 3 is an exemplary rendering of the complimentary prescription sample means of the inventive combination blank and preprinted prescription scripts assembly with the complimentary prescription sample designation included thereon.

### DETAILED DESCRIPTION OF THE PREFERRED EMBODIMENTS

Reference will now be made in detail to the present preferred embodiment of the invention as illustrated in the accompanying drawings.

According to a preferred embodiment, a blank and preprinted prescription scripts assembly is provided for as a combination of two pads, one of which comprises a plurality of preprinted prescription scripts for convenient and reduced-error writing of prescriptions through the provision of a named medication and related possible dosage selections preprinted thereon, and a second comprising a plurality of blank prescription sheets for the convenience of prescribing doctors who wish to prescribe medications other than the one(s) preprinted for their patients, both of which are customized with at least a physician name and contact information that comports with individual state regulations. Printed or stamped thereon, most preferably on each individual preprinted prescription script, is a complimentary prescription sample designation.

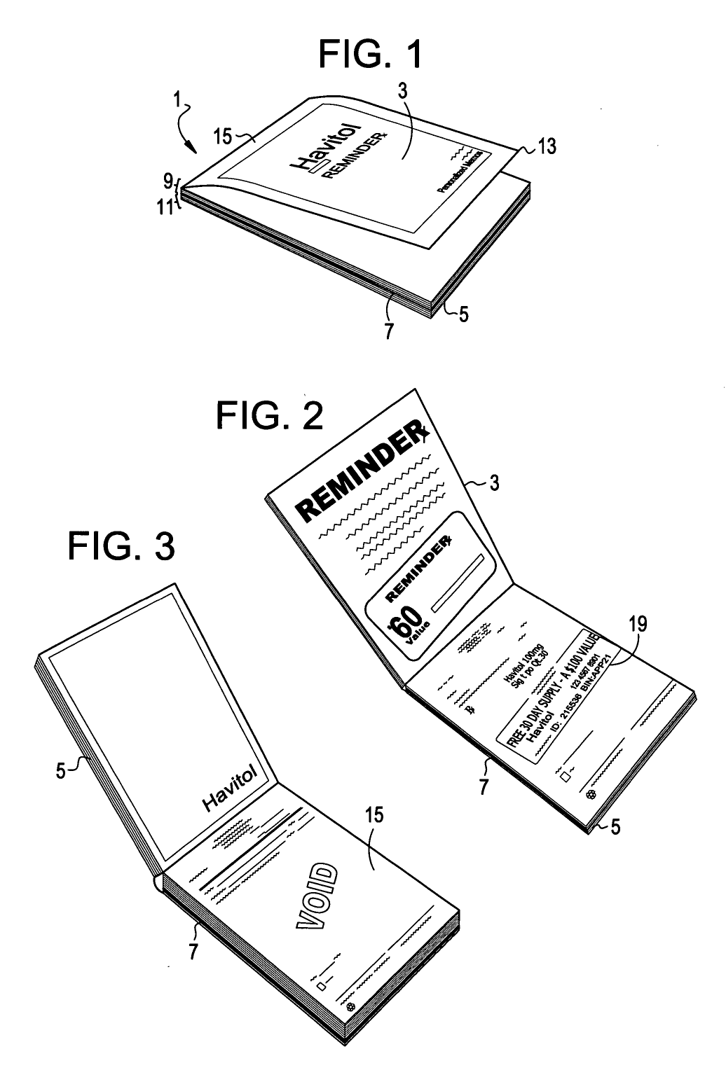

With ongoing reference to FIGS. 1, 2, and 3, the combination blank and preprinted prescription script assembly with complimentary prescription sample means is provided as a blank and preprinted prescription scripts assembly 1 that comprises a preprinted prescription pad 9 and a blank prescription pad 11, having a front cover 3 identifying a target medication to which the preprinted scripts are directed, and a back cover 5 for covering the reverse side of the combination assembly. Preprinted prescription pad 9 and blank prescription pad 11 may further include information such as advertising inserts 13 and/or 13′ distributed throughout the assembly. Flipping or lifting covers 3, 5 exposes the pads 9, 11 of pad assembly 1. Preferably, the covers 3, 5 will be of a substantially stiff material such as thin, printable cardboard, so as to maintain the condition of the sheets in the combination blank and preprinted prescription pad assembly 1. Markings may be printed on the covers 3, 5 to aid in the identification of the particular medication preprinted on the preprinted prescription scripts contained therein. Each type of sheet preferably includes a means of detachment such as a perforation (not depicted) between each of the plurality of sheets 15, 17 respectively, and the spine 15 that binds a top margin of the totality of sheets in a conventional manner. Moreover, a divider 7 may be further provided for ease of use and rapid access to the sections.

Preprinted prescription pad 9 comprises a plurality of preprinted prescription sheets, or scripts 15. In a particular embodiment as shown, each of the plurality of prescription sheets 15 of the preprinted prescription pad 9 has a preprinted prescription on a front face of the sheet for a particular named medication. The plurality of preprinted prescription scripts 15 within a given prescription script pad 9 are all preferably identical. In some required cases, the preprinted prescription scripts 15 may include check-off boxes or the equivalent for indicating predetermined dosage options that can be checked off for the given prescription medicine. For example, for a given preprinted prescription script, the medication will be clearly printed on the script along with a predefined range of dosages that may be checked off, so as to avoid common errors that arise from fully handwritten prescriptions.

Furthermore, all scripts, whether preprinted or blank, will have, in a most preferred embodiment, printed identifying information of the prescriber (doctor name, address, phone number, etc.), zones for patient name and address, etc., as well as various additional features that may be printed, as needed, considering the fact that the exact information and format of the scripts (e.g., colors, watermarks, required substitution options, and the like) will need to be further provided for on the preprinted script as required by individual state laws.

In a preferred embodiment, complimentary prescription sample means 19 may ideally be printed or stamped directly on the front of each of the preprinted prescription scripts of a preprinted prescription pad 9 so as to be part of each preprinted prescription script 15. This would permit direct usage of the printed script (e.g. the prescription script having the stamped or printed complimentary sample designation on it) to be used immediately when filling a prescription (or, alternatively, where a doctor merely desires to give a sample without actually prescribing a medication, he may sign the script proximate to the complimentary sample means so as to allow a sample to be dispensed without necessarily filling a prescription with the script), without any need for sample dispensing (the stamped complimentary sample designation 19 will detail the sample quantity to be dispensed with the regular prescription as filled). Provision in this manner will readily permit a pharmacy to be able to receive reimbursement for the sample dispensing, if needed, given that the sample dispensed is indicated an a signed prescription script. Much like the preprinted prescription scripts themselves, the complimentary sample designation means 19 may have security enhanced features such as water marks, tracking/security codes, and the like within the printing for preventing forgery and/or improper reuse of complimentary sample designation means 19. Provision as such would most preferably be done so as to print a forgery-resistant, numerically sequenced coupon that a prescription recipient may readily redeem for a standard complimentary sample at a pharmacy when presented. Provision of the above offers several advantages. First, it eliminates the need for physicians to keep track of unattached samples and the need to review expiration dates, or for doctors to keep the samples stored in an accessible, climate controlled environment. Second, it provides better security by the centralizing all storage and physical dispensing of pharmaceuticals at a pharmacy, thereby eliminating or reducing problems and costs associated with theft, inadvertent loss, keeping stocks current, excess packaging, etc. Third, it eliminates the need for pharmacies to deal with coupons and the like, as the complimentary designation is printed or stamped directly on the prescription script. Fourth, the present system permits doctors to continue enjoying the on the spot offering of free samples to their patients, while eliminating the safety problems that have historically been presented by the offering of potentially conflicting drugs from differing sources: dispensing sample drugs at the pharmacy by redemption of a doctor endorsed slip means that the patient's pharmacist, who, as a gate-keeper, is in the best position to know the entire grouping of medications that a patient may have been taking, will best be able to prevent adverse drug interactions from occurring.

The blank prescription pad 11 of the combination pad assembly will have a plurality of substantially blank scripts or sheets 17. Most embodiments thereof will have preferably have at least identifying prescribing information, such as prescribing doctor names, signature lines, contact information, possible security watermarks, color codes, etc. In one especially preferred embodiment, the blank prescription pad 11 will be attached to the preprinted prescription pad 9 in an opposite facing direction so as to facilitate access by the doctor. Overall, the configuration of the assembly, especially given the convenience of having the blank prescription pad 11 attached, is designed so as to encourage usage by doctors. When structured as such, doctors who desire to write a range of prescriptions in addition to, or instead of, a commonly prescribed medication for their usual patients will then be inclined to use the all-in-one assembly described herein, rather than carrying around or utilizing separate components.

It is to be understood that the invention is not limited to the illustrations described and shown herein, which are deemed to be more illustrative of the best modes of carrying out the invention, and which are susceptible of modification of form, size, arrangement of parts and details operation. These modifications are within the spirit and scope of the appended claims.

1. A combination blank and preprinted prescription script assembly with complimentary sample means for prescribing prescription medications comprising:
a preprinted prescription pad having a plurality of preprinted prescription scripts, each said preprinted prescription script having a front face;
a blank prescription pad having a plurality of blank prescription scripts, each having a front face, said blank prescription pad attached to said preprinted prescription pad;
said preprinted prescription pad and said blank prescription pad together forming a prescription script assembly;
a plurality of complimentary sample designation means printed on said prescription script assembly.

2. The prescription script assembly of claim 1 wherein said plurality of preprinted prescription scripts are preprinted with a named medication.

3. The prescription script assembly of claim 2 wherein said plurality of preprinted prescription scripts are preprinted with at least one predetermined dosage selection for said named medication.

4. The prescription script assembly of claim 3 wherein said plurality of complimentary sample designation means comprise printed designations redeemable for a selected complimentary prescription sample of said named medication.

5. The prescription script assembly of claim 4 wherein said printed designations are printed directly on said front of said preprinted prescription script.
